(19) United States
(12) Patent Application Publication
(10) Pub. No.: US 2012/0221730 A1
(43) Pub. Date: Aug. 30, 2012

(54) RESOURCE CONTROL SYSTEM AND RESOURCE CONTROL METHOD

(75) Inventor: Akio OBA, Kawasaki (JP)

(73) Assignee: FUJITSU LIMITED, Kawasaki-shi (JP)

(21) Appl. No.: 13/308,858

(22) Filed: Dec. 1, 2011

(30) Foreign Application Priority Data
Feb. 28, 2011 (JP) 2011-042334

(51) Int. Cl. G06F 15/173

(52) U.S. Cl. 709/226

(57) ABSTRACT

A resource control system includes a control unit configured to control to make hardware resources which are allocated to a virtual server increase if an extent of deterioration of response characteristics to requests for processing to the virtual server becomes greater than a certain first extent, and configured to control to change the certain first extent to a smaller second extent of deterioration in accordance with an increase in frequency of access to the virtual server.

### CROSS-REFERENCE TO RELATED APPLICATION

This application is based upon and claims the benefit of priority of the prior Japanese Patent Application No. 2011-042334, filed on Feb. 28, 2011, the entire contents of which are incorporated herein by reference.

### FIELD

The embodiments discussed herein are related to a resource control system and a resource control method.

### BACKGROUND

Virtualization of servers is known. “Virtualization of servers” is concerned with an art of a server running virtualization software so that a single server may run a plurality of operating systems (OS's).

Virtualization of servers is realized by allocating the hardware resources of a single server to a plurality of OS's. An OS which is realized in this way is called a “guest OS”.

“Allocation of hardware resources includes allocation of the rate of usage of a central processing unit (CPU) for each guest OS or allocation of input or output to and from a memory or disk device for each guest OS.

The hardware resources which are allocated to the guest OS's are called “virtual servers” and are used to run the guest OS's. In contrast to the “virtual servers”, the server which runs the virtualization software and provides the hardware resources is called a “physical server”.

In a data center, several physical servers are installed, so a data center may provide a large number of virtual servers to users. As a result, in a data center, operational management is performed to allocate the hardware resources from the plurality of physical servers which the data center holds as a whole to the plurality of virtual servers. Note that, the allocation of hardware resources to virtual servers is called “provisioning”.

As one method for such operational management, there is the method of using a configuration management database (CMDB). A CMDB is a database which records the virtual servers and the services and other configuration items (CI) and their attributes and records the relationships among the CI's.

With the method of using a CMDB, the hardware resources in the data center or application services and other services are recorded as configuration items in the CMDB. The CMDB uses the recorded configuration items to evaluate the need of the hardware resources to be allocated to the virtual servers which perform services in the data center as a whole and allocate or recover hardware resources in accordance with that evaluation.

By allocating or recovering hardware resources in accordance with the evaluation of need of performing services, the CMDB may automatically allocate hardware resources tailored to the roles and statuses of the virtual servers performing services in actual operations. Such automatic allocation of hardware resources to the virtual servers is called “automatic programming”.

As one type of automatic programming, there is one which investigates the state of use of hardware resources or response time at each server. That is, threshold values of the response time are set in advance. When above or below the threshold values, the hardware resources are allocated or recovered.

In this regard, in the past, various types of resource control techniques have been proposed.
Patent Document 1: Japanese Laid-open Patent Publication No. 2005-174201
Patent Document 2: Japanese Laid-open Patent Publication No. 2008-217285
Patent Document 3: Japanese Laid-open Patent Publication No. 2005-182641

### SUMMARY

According to an aspect of the embodiments, a resource control system includes a control unit. The control unit is configured to control to make hardware resources which are allocated to a virtual server increase if an extent of deterioration of response characteristics to requests for processing to the virtual server becomes greater than a certain first extent.

Further, the control unit is configured to control to change the certain first extent to a smaller second extent of deterioration in accordance with an increase in frequency of access to the virtual server.

The object and advantages of the embodiments will be realized and attained by the elements and combinations particularly pointed out in the claims.

It is to be understood that both the foregoing general description and the following detailed description are exemplary and explanatory and are not restrictive of the embodiments, as claimed.

### BRIEF DESCRIPTION OF DRAWINGS

FIG. 1 is a view which illustrates one example of automatic programming which allocates hardware resources based on a threshold value of a response time;

FIG. 2 is a view which illustrates one example of an information system in which automatic programming is executed illustrated in FIG. 1;

FIG. 3 is a view which illustrates a relationship between a response time run-over rate of a virtual server and allocation or recovery of hardware resources to or from a virtual server;

FIG. 4 is a view for explaining an example of an information system;

FIG. 5 is a view which illustrates an example of a hardware configuration of a resource control system;

FIG. 6 is a view which illustrates one example of a memory map of a storage unit;

FIG. 7 is a view which illustrates one example of functional configuration blocks of a resource control system;

FIG. 8A is a view (part 1) which illustrates one example of configuration information in a CMDB;

FIG. 8B is a view (part 2) which illustrates one example of configuration information in a CMDB;

FIG. 9 is a view which illustrates one example of resource allocation control information;

FIG. 10 is a view which illustrates one example of request response time information;

FIG. 11 is a view which explains an outline of processings which a priority degree calculation unit and a resource allocation control unit perform;

FIG. 12 is a view which illustrates a relationship between a programming management unit and guest OS's;

FIG. 13 is a flow chart which illustrates an overall outline of the processing by a resource control system;

FIG. 14 is a view illustrating an example of a flow of calculation of priority degrees;

FIG. 15A is a flow chart (part 1) which illustrates one example of control processing for a resource allocation amount; and

FIG. 15B is a flow chart (part 2) which illustrates one example of control processing for a resource allocation amount.

### DESCRIPTION OF EMBODIMENTS

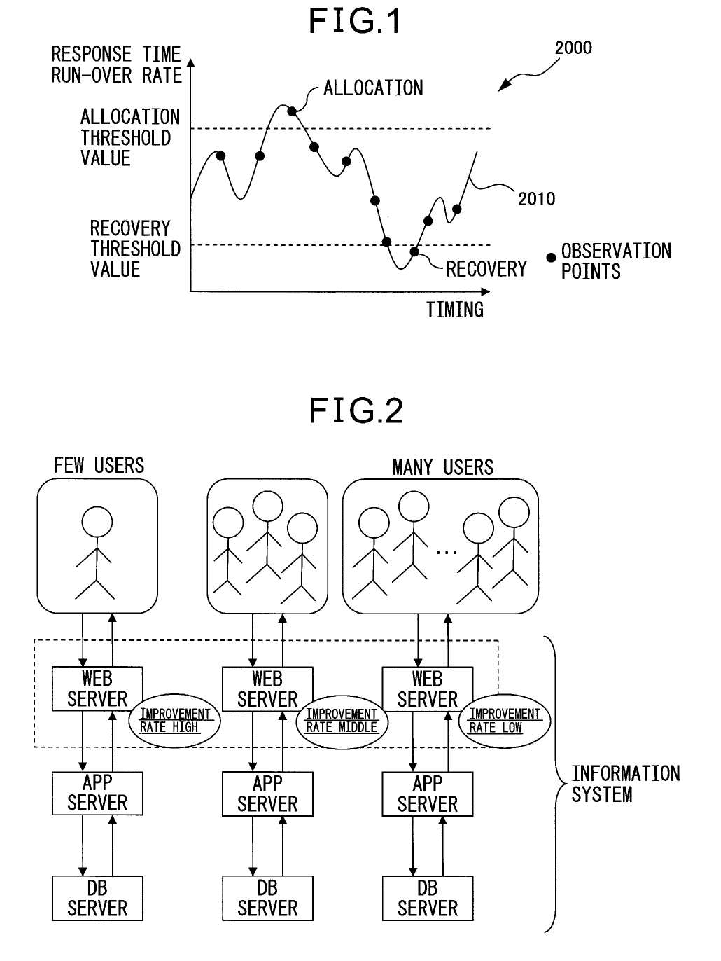

First, before explaining embodiments of the resource control system, resource control method, and resource control program, an example of automatic programming and an example of an information system where automatic programming is run will be explained with reference to FIG. 1 and FIG. 2.

FIG. 1 is a view which illustrates one example of automatic programming which allocates hardware resources based on a threshold value of a response time. An ordinate of a graph 2000 illustrated in FIG. 1 indicates a response time run-over rate of a virtual server. An abscissa indicates time. The response time run-over rate is calculated at periodic times illustrated by observation points.

Here, the “response time run-over rate” is an observed response time divided by a request response time, while the request response time is defined by a service level agreement (SLA). The curve 2010 indicates a trend along with time of the response time run-over rate of a virtual server which provides a certain service.

An allocation threshold value which is illustrated in FIG. 1 is a threshold value for allocation of new hardware resources to a virtual server. When the response time run-over rate of a virtual server is the allocation threshold value or more, it is useful to raise the processing capability of the virtual server, so the virtual server is allocated new hardware resources.

A recovery threshold value which is illustrated in FIG. 1 is a threshold value by which hardware resources are recovered from a virtual server. In FIG. 1, when the response time run-over rate of a virtual server is the recovery threshold value or less, the virtual server has been allocated excessive hardware resources, so hardware resources are recovered from the virtual server.

FIG. 2 is a view which illustrates one example of an information system in which automatic programming is executed and which is illustrated in FIG. 1. The information system which is illustrated in FIG. 2 is comprised of three systems including web servers, application servers (app servers), and database (DB) servers which provide respective services to users which utilize client computers.

The automatic programming system such as illustrated in FIG. 1 manages the hardware resources so that the response times of the individual virtual servers fall between the allocation threshold value and the recovery threshold value.

However, if the provisioning system which is illustrated in FIG. 1 is uniformly applied to all web servers which are illustrated in FIG. 2, both virtual servers which have large numbers of utilizing users and handle important services and non-such virtual servers will all end up having hardware resources allocated or recovered in the same way.

That is, virtual servers which provide services with large numbers of utilizing users will be insufficiently allocated hardware resources, while virtual servers which provide services with small numbers of utilizing users will be excessively allocated them. As a result, a greater number of users will be made to experience deterioration of the response times and the data center will lose trust.

In this way, it is not possible to allocate hardware resources to all virtual servers while taking into consideration the roles and statuses of the virtual servers of the data center as a whole in operation, so it is not possible to secure the quality of the response time on a priority basis in the limited hardware resources for services with large numbers of utilizing users.

As explained above, as a cause why it is not possible to secure the quality of the response time on a priority basis for services with large numbers of utilizing users, hardware resources are not being allocated in consideration of the services handled by the virtual servers and the numbers of users.

Therefore, by distributing hardware resources tailored to the actual services and numbers of users of the virtual servers in a data center, it is possible to avoid insufficient resources at virtual services which provide services with large numbers of users and excessive resources at virtual servers which are not used that much. Due to this, the quality of the response time of services which many users utilize is secured on a priority base. This leads to improvement in trust.

Below, embodiments of a resource control system, resource control method, and resource control program will be explained in detail with reference to the attached drawings.

### [1] Allocation and Recovery of Hardware Resources Using Priority Degrees

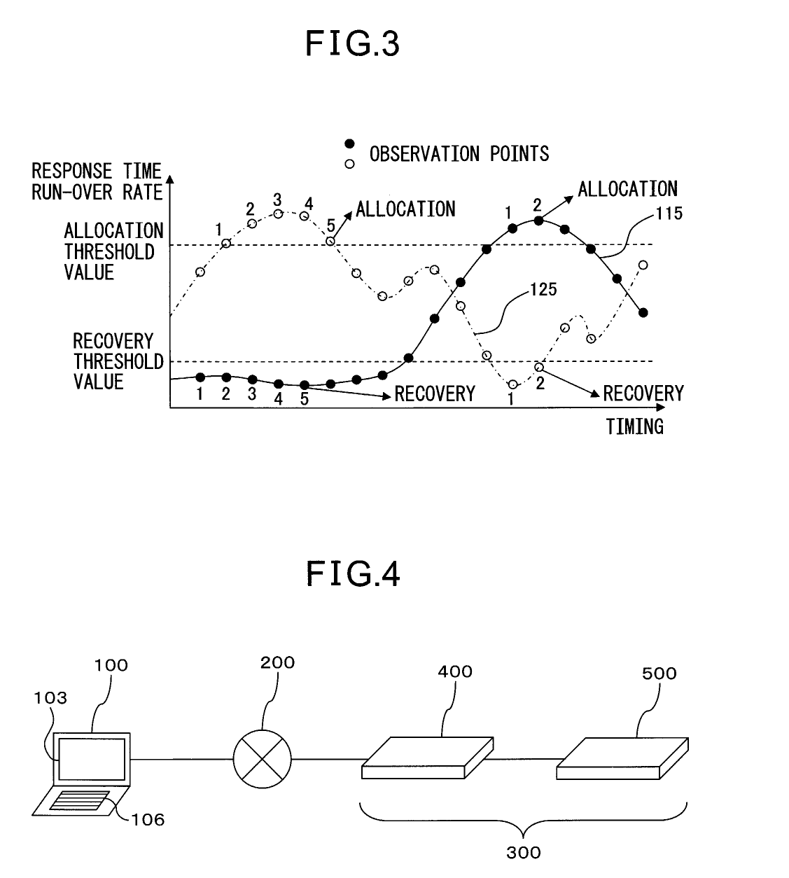

First, the allocation and recovery of hardware resources using the priority degrees will be explained using FIG. 3. FIG. 3 is a view which illustrates the relationship between the response time run-over rate of a virtual server and the allocation or recovery of hardware resources to or from the virtual server. The “response time run-over rate” is an observed response time divided by a request response time, while the request response time is defined by the SLA.

The “SLA” is an agreement by which the owner of the data center guarantees a user a certain quality of service. An SLA includes a minimum communication speed of the lines, an average delay time in a network, an upper limit of down time, and other guarantee items in the quality of service and provisions relating to reduction of usage rates when these may not be realized.

The “response time” is, for example, the time from which data is requested from a client computer to when a response is returned in a connection established between a virtual server and the client computer observed at an observation point.

The response time run-over rate is one example of a response time of a virtual server with respect to a request from a user and, further, is one example of the processing capability of a virtual server for a user request. Note that, an “observation point” is a sampling point of certain time intervals.

The “priority degree” is an indicator which determines the frequency by which hardware resource allocation is requested. The higher the priority degree of a virtual server, the shorter the time until the virtual server is allocated resources after the processing capability of the virtual server becomes the allocation threshold value or more. Further, the higher the priority degree of a virtual server, the longer the time until resources are recovered from the virtual server after the processing capability of the virtual server becomes the recovery threshold value or less.

A curve 115 which illustrates the trend along with time of the response time run-over rate which is illustrated in FIG. 3 illustrates the trend along with time of the response time run-over rate of a virtual server with a high priority degree of hardware resource allocation. A curve 125 which illustrates the trend along with time of the response time run-over rate which is illustrated in FIG. 3 illustrates the trend along with time of the response time run-over rate of a virtual server with a low priority degree of hardware resource allocation. The observation points which are illustrated in FIG. 3 illustrate timings for observation of the response time run-over rate. The number of observation points which continue after the allocation threshold value is exceeded or the recovery threshold value is fallen below will be referred to as “the count number”. The priority degree may be defined by the count number.

The curve 115 illustrates that the system starts allocating hardware resources two counts after the allocation threshold value is exceeded, while the curve 125 illustrates that the system starts allocating hardware resources five counts after the allocation threshold value is exceeded.

Similarly, the curve 115 illustrates that the system recovers hardware resources five counts after the recovery threshold value is exceeded, while the curve 125 illustrates that the system recovers hardware resources two counts after the recovery threshold value is exceeded.

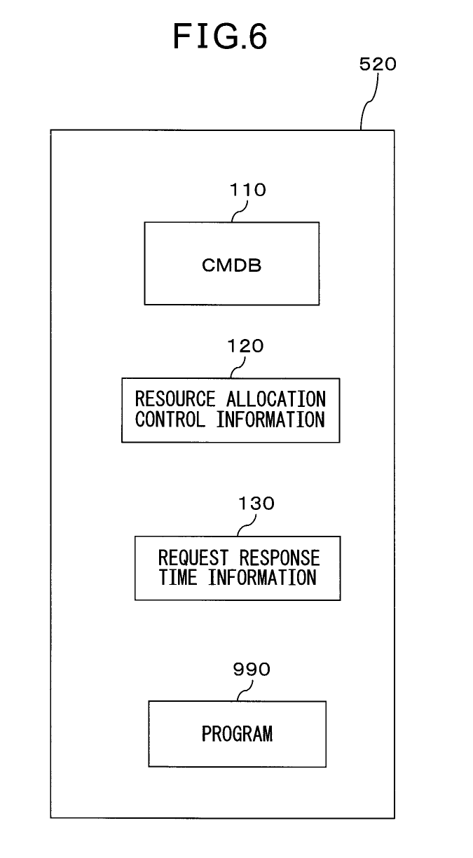

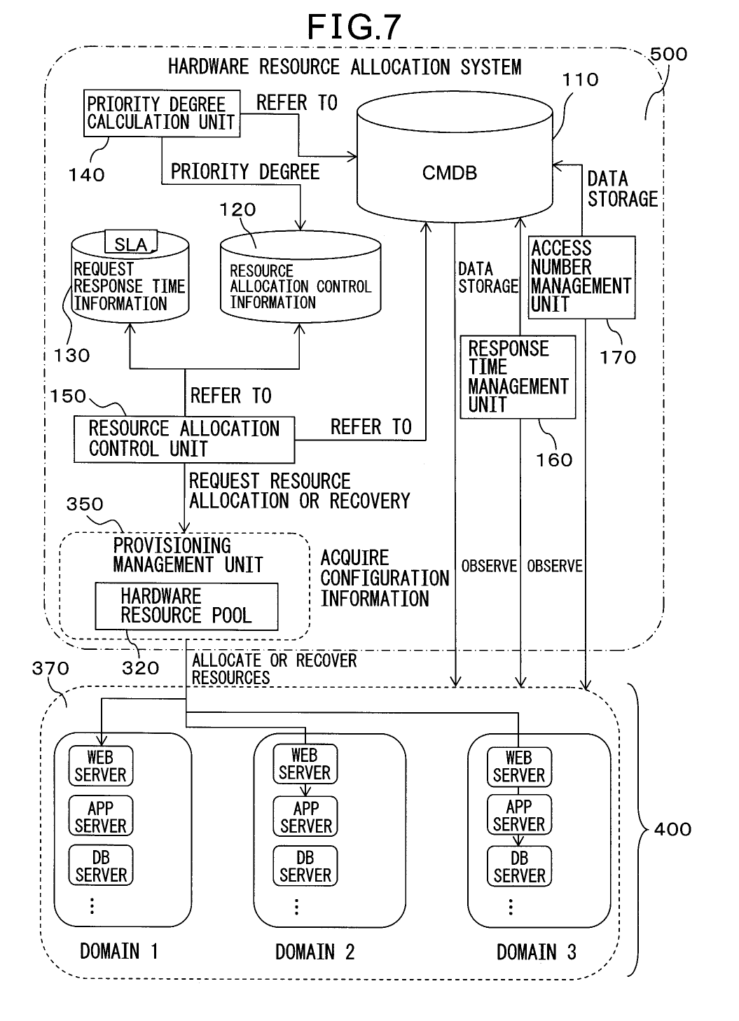

Table 1 illustrated below is an example which defines the priority degree by the allocation count threshold value and the recovery count threshold value. Note that, Table 1 corresponds to the resource allocation control information explained later using FIG. 6, FIG. 7, and FIG. 9.

TABLE 1

| | Allocation count | Recovery count |
|---|---|---|
| Priority degree | threshold value | threshold value |
| 1 | n | 1 |
| 2 | n − 1 | 2 |
| 3 | n − 2 | 3 |
| 4 | n − 3 | 4 |
| 5 | n − 4 | 5 |
| . . . | . . . | . . . |
| n | 1 | n |

An “allocation count value” is the number of observed values when a response time run-over rate of a virtual server exceeds its allocation threshold value, while an “allocation count threshold value” is a boundary value for judging whether to allocate hardware resources.

When an allocation count value reaches the allocation count threshold value, the virtual server for which the allocation count is being observed is allocated hardware resources.

A “recovery count value” is the number of observed values when a response time run-over rate of a virtual server falls to its recovery threshold value or les, while a “recovery count threshold value” is a boundary value for judging whether to recover hardware resources. When a recovery count value reaches the recovery count threshold value, the virtual server for which the recovery count is being observed has hardware resources recovered from it.

In Table 1, the larger the value of the priority degree, the higher the priority degree that is illustrated. The “n” illustrated in Table 1 illustrates the maximum rush priority degree. The virtual server with the high priority degree which is illustrated by the curve 115 of FIG. 3 has a priority degree of “5”, while the virtual server with the low priority degree which is illustrated by the curve 125 of FIG. 3 has a rush priority degree of “2”.

Referring to Table 1, if making the maximum priority degree “n” “6”, when the priority degree is “5”, the virtual server with the high priority degree which is illustrated by the curve 115 has an allocation count threshold value of “6−4=2” and has a recovery count threshold value of “5”. Further, when the priority degree is “2”, the virtual server with the low priority degree which is illustrated by the curve 125 has a recovery count threshold value of “6−2=4” and has a recovery count threshold value of “2”.

Accordingly, the virtual server with the high priority degree which is illustrated by the curve 115 has an allocation count threshold value of “2”, so when the response time run-over rate becomes the allocation threshold value or more at two consecutive observation points, the virtual server is allocated hardware resources.

On the other hand, the curve 125 which is illustrated in FIG. 3 has an allocation count threshold value of “5”, so when the response time run-over rate becomes the allocation threshold value or more at five consecutive observation points, a virtual server with a low priority degree is allocated hardware resources. In this way, a virtual server with a high priority degree is allocated hardware resources earlier when the response time run-over rate becomes the resource allocation threshold value or more.

Further, the virtual server with the high priority degree which is illustrated by the curve 115 has a recovery count threshold value of “5”, so when the response time run-over rate becomes the recovery threshold value or less at five consecutive observation points, hardware resources are recovered from the virtual server.

On the other hand, the curve 125 which is illustrated in FIG. 3 has a recovery count threshold value of “2”, so when the response time run-over rate becomes the recovery threshold value or less at two consecutive observation points, hardware resources are recovered from the virtual server with a low priority degree. In this way, a virtual server with a high priority degree has hardware resources recovered from it later when the response time run-over rate becomes less than the resource recovery threshold value.

In this way, a virtual server with a high priority degree is allocated hardware resources faster than a virtual server with a low priority degree when the response time accompanying running of an application for a request from a user becomes long.

Further, a virtual server with a high priority degree has hardware resources recovered from it later than a virtual server with a low priority degree when the response time accompanying running of an application for a request from a user becomes short.

Therefore, by setting a priority degree of a virtual server which provides a service with a large number of utilizing users higher than a virtual server which provides a service with a small number of utilizing users, it is possible to secure the quality of the response time on a priority basis.

Below, [2] the configuration of the information system including a resource control system which allocates hardware resources in accordance with a priority degree which is illustrated using Table 1 and FIG. 3, [3] the hardware configuration of the resource control system, and [4] the functional configuration of the resource control system will be explained. Further, [5] the programming management unit and physical server and [6] the flow chart of resource control processing performed by the resource control system will be explained in that order.

### [2] Configuration of Information System

FIG. 4 is a view which explains one example of an information system. The information system 300 has a resource control system (hardware resource allocation system) 500 and a physical server 400. The physical server 400 connects with a client computer comprised of the client 100 through the Internet or another network 200. The information system 300 is, for example, installed at a data center.

The number of clients 100 which access the information system 300 installed at the data center is huge. Therefore, the number of clients 100 is not limited to the single one which is illustrated in FIG. 4 and may be a larger number. Further, the number of physical servers 400 corresponds to the number of servers installed at the data center, so the number of physical servers 400 is not limited to the single one which is illustrated in FIG. 4 and may be a larger number as well.

Each physical server 400 realizes a plurality of virtual servers which provide the clients 100 with services. The resource control system 500 allocates or recovers hardware resources to and from the plurality of virtual servers which the physical server 400 realizes.

Each client 100 sends requests for services which are provided by the virtual servers through the network 200 to the physical server 400. The client 100 has a central processing unit (CPU), a main memory, and a network interface card (NIC) which are not illustrated in FIG. 4 and a display 103 and an input device 106 which are illustrated in FIG. 4.

The input device 106 is, for example, a keyboard. The CPU of the client 100 runs a Web browser and generates requests to the physical server 400 in accordance with information which is input from the input device 106.

The CPU of the client 100 controls the NIC to send requests and receive responses to the requests from the physical server 400. When the CPU of the client 100 receives a response from the physical server 400, it runs a Web browser and displays the response on the display 103.

### [3] Hardware Configuration of Resource Control System

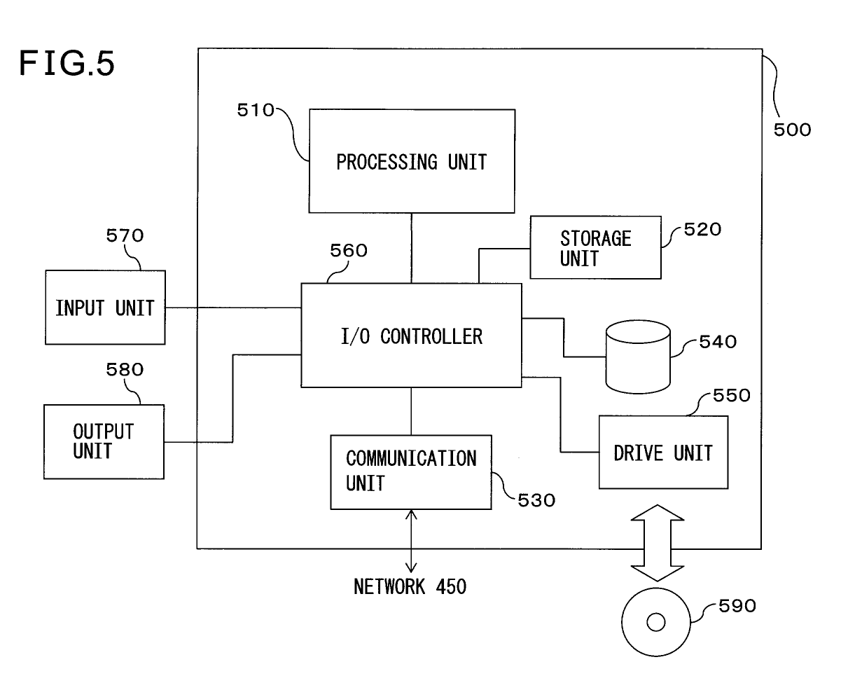

Next, the hardware configuration of the resource control system will be explained. FIG. 5 is a view which illustrates one example of the hardware configuration of the resource control system. As illustrated in FIG. 5, the resource control system 500 has a processing unit 510, storage unit 520, communication unit 530, auxiliary storage unit 540, drive unit 550, and I/O controller 560. Note that the resource control system 500, as illustrated in the later explained FIG. 7, may include a programming management unit 350.

The processing unit 510 is connected through the I/O controller 560 to the communication unit 530, auxiliary storage unit 540, and drive unit 550. The processing unit 510 runs programs which are stored in the storage unit 520 so as to load data from the storage unit 520, process the loaded data, and store the processing results in the storage unit 520. The processing unit 510 is, for example, a CPU.

The I/O controller 560 is a device which controls the connection between the processing unit 510 and other connected devices. The I/O controller 560, for example, operates in accordance with the PCI Express (Peripheral Component Interconnect Express) or other standard.

The storage unit 520 is a device which stores the data or programs. The storage unit 520 is, for example, a dynamic random access memory (DRAM). FIG. 6 is a view illustrating an example of a memory map of the storage unit. As illustrated in FIG. 6, the storage unit 520 stores the CMDB 110, resource allocation control information 120, request response time information 130, and program 990.

The CMDB 110 and the resource allocation control information 120 will be explained later using the request response time information 130 and FIG. 9. The program 990, as illustrated using FIG. 3, is a hardware resource allocation program for allocating hardware resources in accordance with the priority degree. The processing unit 510 runs the program 990 to control allocation of hardware resources to the virtual servers as illustrated by the later explained resource control processing [6].

The communication unit 530 is a device which is connected with a communication channel comprised of the network and sends and receives data to and from other information processing systems which are connected to the network. The communication unit 530 is, for example, a network interface controller (NIC).

The auxiliary storage unit 540 is a nonvolatile device which may hold information even without the supply of power and which stores the programs and data which are stored in the storage unit 520. The auxiliary storage unit 540 is a display array using magnetic disks or a solid state drive (SSD) using a flash memory etc.

The drive unit 550 is, for example, a device which reads and writes from and to a Floppy® disk or CD-ROM (Compact Disc Read Only Memory), DVD (Digital Versatile Disc), or other storage medium 590. The drive unit 550 includes a motor which makes the storage medium 590 spin, a head which reads and writes data from and to the storage medium 590, etc. Note that, the storage medium 590 may store programs.

The drive unit 550 reads out the program 990 from the storage medium 590 which is set in the drive unit 550. The processing unit 510 stores the program 990 which was read out from the drive unit 550 to the storage unit 520 or auxiliary storage unit 540.

The input unit 570 is a device which outputs an input signal to the processing unit 510, for example, a keyboard or mouse. The output unit 580 is a device which displays the output signal which is output from the processing unit 510, for example, a display.

Note that, the physical server 400 may also have a hardware configuration similar to the hardware configuration of the above resource control system 500. However, the storage unit of the physical server 400 stores virtualization software, a plurality of OS's, and programs for services which the virtual servers provide.

### [4] Functional Configuration of Resource Control System

FIG. 7 is a view illustrating one example of the functional configuration blocks of the resource control system. The resource control system (hardware resource allocation system) 500 has an CMDB 110, resource allocation control information 120, request response time information 130, priority degree calculation unit 140, resource allocation control unit 150, response time management unit 160, and access number management unit 170. The priority degree calculation unit 140, resource allocation control unit 150, response time management unit 160, and access number management unit 170 are units which are realized by the processing unit 510 running the program 990.

The resource control system 500 collects configuration information and information on operating conditions relating to the physical server 400 in the CMDB 110. The resource control system 500 calculates the priority degrees of the virtual servers in the physical server 400 based on the numbers of accesses collected at the CMDB 110 and allocates hardware resources to the physical server 400 based on the response time and the calculated priority degrees. In this way, the resource control system 500 may allocate the resources and may dynamically calculate the priority degrees.

The programming management unit 350 manages the hardware resources, which are comprised of at least one physical server 400, as a hardware resource pool 320. Here, in FIG. 7, the programming management unit 350 is drawn including the hardware resource allocation system (resource control system 500), but this may also be provided as a physical server separate from the resource control system 500.

The plurality of virtual servers 370 are virtual servers which are generated by the physical server 400 running virtualization software. Each virtual server, as explained above, is allocated hardware resources or has the resources recovered from them by the programming management unit 350 and operates as a Web server, application server, DB server, or other server.

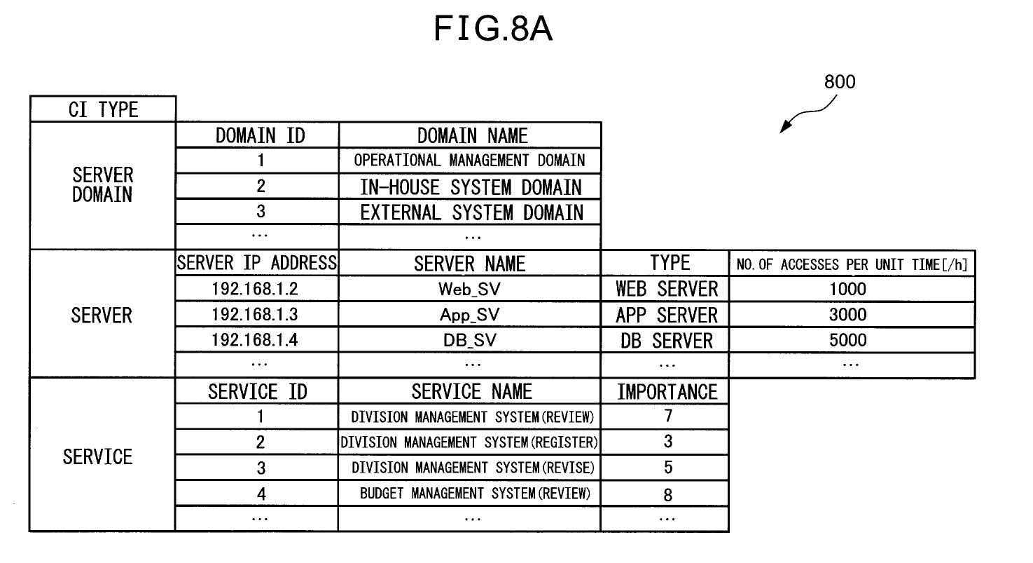

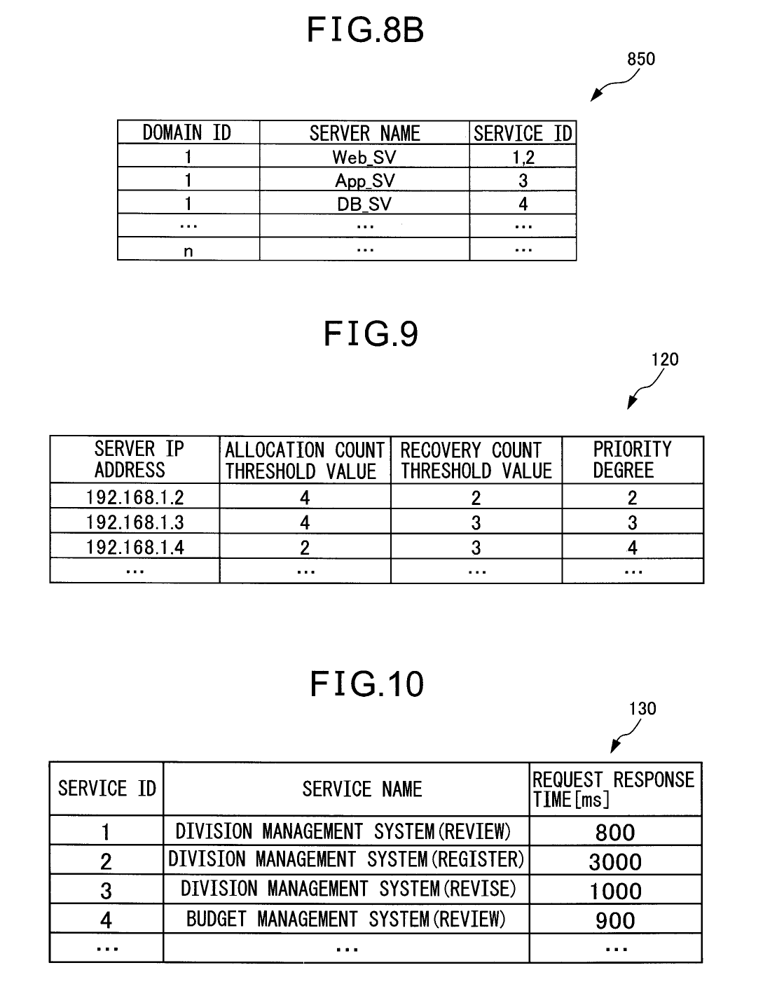

The functional configuration blocks which are illustrated in FIG. 7 will be explained with reference to the detailed examples of the configuration information, resource allocation control information 120, and request response time information 130 in the CMDB 110 which are illustrated in FIG. 8 to FIG. 10.

### [4.1] Response Time Management Unit

The response time management unit 160 observes the response time of each virtual server realized by the physical server 400 to access of external clients and stores the observed response time in the configuration information in the CMDB 110. The access number management unit 170 observes the number of outside accesses to the physical server 400 and stores the observed number of outside accesses in the configuration information 800 in the CMDB 110. Note that, the settings of the configuration information are defined in the SLA.

FIG. 8A and FIG. 8B are views of one example of the configuration information in the CMDB. In the configuration information 800 which is illustrated in FIG. 8A, as CI types, a “server domain”, “server”, and “service” are registered. The servers which are managed by the configuration information 800 are virtual servers.

In the “server domain” CI, the “domain ID” and “domain name” are registered in correspondence. In the “server” CI, the “server IP address”, “server name”, “type”, and “number of accesses per unit time” are registered in correspondence. Depending on the type of the virtual server, the “number of accesses per unit time”, for example, is the number of connections requested from clients and established per unit time. The number of accesses per unit time changes depending on the type of the virtual server. The “number of accesses per unit time” is utilized for calculation of the priority degree. A virtual server with a high “number of accesses per unit time” is a virtual server which provides services with a large number of utilizing users, so a high priority degree is set.

In the “service” CI, the “service ID”, “service name”, and “degree of importance” are recorded in correspondence. The “degree of importance” is a setting based on the SLA. The degree of importance changes depending on the service.

In the configuration information 850 which is illustrated in FIG. 8B, the “server domain”, “server name”, and “service ID” are recorded in correspondence. In the example which is illustrated in FIG. 8B, the server domain with the domain ID “1” is comprised of the virtual servers of the “Web SV”, “App SV”, and “DB SV”. The virtual servers of the “Web SV”, “App SV”, and “DB SV” provide services specified by the service ID's “1, 2”, “3”, and “4”.

### [4.2] Priority Degree Calculation Unit

The priority degree calculation unit 140 refers to the number of accesses which is stored in the configuration information to acquire the attribute values for calculation of the priority degrees of the virtual servers from the CMDB 110 and calculate the priority degrees. The priority degree calculation unit 140 sets the priority degree higher the larger the number of accesses per unit time.

The priority degree calculation unit 140 stores the calculated priority degree in the resource allocation control information 120. The priority degree calculation unit 140 uses the “degree of importance” and “number of accesses per unit time” which are registered in the configuration information 800 of FIG. 8A to calculate the “design error value” and “actual error value” and calculates the priority degree from the “design error value” and “actual error value”.

The priority degrees are calculated based on the response times of the virtual servers in the data center as a whole. The actual needs of hardware resources at the virtual servers are reflected in the priority degrees. It is possible to confirm services with large numbers of utilizing users in real time.

The priority degree, for example, is defined as follows:

Priority degree=(design error value+actual error value)/2 (formula 1)

The meanings of the two variables of formula 1 are as follows:

The design error value is an indicator of the degree of importance of each virtual server which is evaluated in the operating system of services and virtual servers. The design error value may be defined in the SLA. Since the design error value may be determined based on the SLA, a user who utilizes the data center may be provided with fine service in which the quality of the response time is secured on a priority basis.

The design error value is calculated from the “degree of importance” of the service CI of the configuration information 800. For example, as illustrated in the configuration information 800 of FIG. 8A, the degree of importance changes depending on the service name of the service CI. The design error value is the error value which illustrates at what kind of position in a parent population each degree of importance occupies when referring to the degree of importance in the configuration information in the CMDB 110 and defining all degrees of important of services provided by the data center as a whole as the parent population.

The actual error value is an indicator of the degree of importance of each virtual server and is evaluated by to what extent each virtual server is utilized from the outside. The actual error value is calculated from the “number of accesses per unit time” of the server CI of the configuration information 800.

The actual error value is the error value which illustrates at what kind of position in a parent population each virtual server occupies when defining the “number of accesses per unit time” to the virtual servers executed in the data center as a whole as the parent population.

Note that, the role performed by the CMDB 110 in calculation of the actual error value is not just the provision of the response time or number of accesses. The priority degree is calculated by eliminating the bias in the number of accesses by type by considering also the “server type” in the server CI of the configuration information 800 which the CMDB 110 manages.

Due to this, it becomes possible to quantify what extent of number of accesses each domain which provides specific services to users has in the number of accesses of the data center as a whole.

As illustrated in the above formula 1, the priority degree may be defined by the design error value which may be defined by the SLA and the actual error value based on the quantitative number of accesses. Alternatively, the priority degree may be determined by just the actual error value. Note that, as illustrated in formula 1, when making the design error value an operating variable of the priority degree, it becomes possible to secure the quality of the response time on a priority basis for services with large numbers of utilizing users and also possible to provide the quality of the response time based on the SLA to the user.

The priority degree calculation unit 140 sets priority degrees which are higher the larger the average values of the design error values and actual error values for the different virtual servers and determines allocation count threshold values and recovery count threshold values in accordance with the same. The count threshold values are, for example, set ranked as follows in accordance with the priority degrees. Note that, the number of accesses per unit time of a certain virtual server—the average of the number of accesses per unit time of all virtual servers is defined as “x”, while the standard error of the number of accesses per unit time of all virtual server is defined as “σ”.

TABLE 2

| Priority | | Allocation count | Recovery count |
|---|---|---|---|
| degree | Condition | threshold value | threshold value |
| 1 | x ≦ 2 − σ | 6 | 1 |
| 2 | −2σx ≦ −σ | 5 | 2 |
| 3 | −σx ≦ 0 | 4 | 3 |
| 4 | 0 < x ≦ σ | 3 | 4 |
| 5 | σx ≦ 2σ | 2 | 5 |
| 6 | 2σ < x | 1 | 6 |

The priority degree calculation unit 140 uses the calculated priority degrees as the basis to determine the allocation or recovery count threshold value for each virtual server and registers this in the resource allocation control information 120.

FIG. 9 is a view which illustrates one example of resource allocation control information.

The resource allocation control information 120 differs from the resource allocation control information which is illustrated in Table 1 and includes the “allocation count threshold value”, “recovery count threshold value”, and “priority degree” in correspondence plus the “server IP address”. The “server IP address” is used to link with the configuration information 800 and 850 of the virtual servers, so the priority degree calculation unit 140 may register the calculated priority degree in the resource allocation control information 120 for each virtual server based on the configuration information 800 and 850.

The “allocation count threshold value” and the “recovery count threshold value”, as explained in FIG. 3, are applied to the numbers of observed values where the response time run-over rates of virtual servers become the allocation threshold value or more or become the recovery threshold value or less (allocation/recovery count values).

The allocation/recovery count value is given the following properties:

When the observed response time run-over rate is less than the recovery threshold value, the recovery count value is increased by “1”, while when it is the allocation threshold value or more, the allocation count value is increased by “1”.

When the observed response time run-over rate, in comparison with the previous observed value, spans the allocation threshold value from the top to the bottom, the allocation count value is made “0”, while when it spans the recovery threshold value from the bottom to the top, the recovery count value is made 0.

When the hardware resources are allocated, the allocation count value is made “0”, while if they are recovered, the recovery count value is made “0”.

### [4.3] Resource Allocation Control Unit

The resource allocation control unit 150 compares the request response time in the request response time information 130 and the response time which the response time management unit 160 observed and determines allocation or recovery of hardware resources to and from each virtual server based on the content of the resource allocation control information 120. The determined results are informed to the programming management unit 350. The programming management unit 350 is used to allocate or recover hardware resources to and from the virtual servers in the physical server 400.

The resource allocation control unit 150 refers to the response time of each virtual server through the response time management unit 160 and finds the run-over rate from the request response time in the request response time information 130 (response time run-over rate).

FIG. 10 is a view illustrating an example of the request response time information. The request response time information 130 comprises the “service ID”, “service name”, and “request response time [ms]” registered in correspondence. Note that, the request response time is a setting based on the SLA

The resource allocation control unit 150, as illustrated in FIG. 3, calculates if the response time run-over rate has become the allocation threshold value or more or has become the recovery threshold value or less. Further, when the response time run-over rate has become the allocation threshold value or more or has become the recovery threshold value or less, the resource allocation control unit 150 counts the number of observation points where the rate consecutively became the allocation threshold value or more or recovery threshold value or less (allocation or recovery count value).

Note that, the response time run-over rate is defined as follows:

Response time run-over rate=Observed response time/request response time (formula 2)

Note that, as explained above, the request response time is registered in the request response time information 130 and is a value determined by the SLA.

The resource allocation control unit 150 allocates or recovers hardware resources in accordance with the following definition. When, for a certain virtual server, the condition of consecutive interrupts (recovery threshold value) recovery count threshold value stands, the resource allocation control unit 150 recovers the previous allocated hardware resources from the virtual server.

When, for a certain virtual server, the condition of allocation count value allocation count threshold value stands, the resource allocation control unit 150 allocates hardware resources for that virtual server. The resource allocation control unit 150 does not allocate or recover hardware resources in cases of conditions other than the above.

Further, the resource allocation control unit 150 may add a correction amount obtained by feedback to the allocation count threshold value or recovery count threshold value. The resource allocation control unit 150 observes the response time run-over rate by a certain sampling time.

If the response time run-over rate greatly changes in current observed value from the previous observed value, this indicates that the accesses from the users have greatly changed, so the resource allocation control unit 150 greatly changes the count threshold value by a large correction amount to speed the hardware resource allocation or recovery.

The resource allocation control unit 150 corrects the allocation count threshold value to become smaller if the response time changes to become longer or corrects the recovery count threshold value to become smaller if the response time changes to become shorter.

For example, it finds, from the following such table of combinations of conditions of previous observed values and current observed values of the run-over rate, the “(correction amount of allocation count threshold value and correction amount of recovery count threshold value)”.

TABLE 3

| Response time run- | Response time run-over rate (current) | | |
|---|---|---|---|
| over rate (previous) | Run over region | Normal region | Excess region |
| Run over region | (−1, 0) | (0, −1) | (0, −2) |
| Normal region | (−1, 0) | (0, 0) | (0, −1) |
| Excess region | (−2, 0) | (−1, 0) | (0, −1) |

Run over region: Region where response time run-over rate ≧ allocation threshold value is satisfied
Excess region: Region where response time run-over rate ≦ recovery threshold value is satisfied
Normal region: Region other than above two

The resource allocation control unit 150 adds the found correction amount to the allocation/recovery count threshold value. However, if the threshold value after correction becomes “0” or less, the value is made “1”, while if it becomes 7 or more, the value is made “6”.

When a certain virtual server where the response time run-over rate was the “run-over region” or “normal region” in the previous observation has a response time run-over rate which becomes the “run-over region” in the current observation, the resource allocation control unit 150 corrects the allocation count threshold value by “−1”. Due to the reduction of the allocation count threshold value, the resource allocation control unit 150 allocates hardware resources faster to virtual servers with response time run-over rates in the “run-over region” than cases of no correction.

When a certain virtual server whose response time run-over rate was the “excess region” in the previous observation has a response time run-over rate in the “run-over region” in the current observation, this indicates that accesses from users have rapidly increased from the previous observation.

The resource allocation control unit 150 allocates hardware resources by a threshold value of the allocation count threshold value corrected by “−2” and thereby allocates hardware resources faster to virtual servers with response time run-over rates changing from the “excess region” to the “run-over region” compared with the case where the response time run-over rate was the “run-over region” or “normal region” in the previous observation.

When a certain virtual server whose response time run-over rate was the “run over region” in the previous observation has a response time run-over rate which becomes the “normal region” in the current observation, the resource allocation control unit 150 corrects the recovery count threshold value by “−1”. A certain virtual server whose response time run-over rate becomes the “excess region” due to the reduction of the recovery count threshold value has hardware resources recovered from it faster than the case of no correction.

When a certain virtual service whose response time run-over rate was the “excess region” in the previous observation has a response time run-over rate which becomes the “normal region” in the current observation, this indicates that accesses from users have increased from the previous observation. The resource allocation control unit 150 allocates hardware resources by a threshold value of the allocation count threshold value corrected by “−1” and thereby allocates hardware resources faster to virtual servers with response time run-over rates changing from the “excess region” to the “normal region” compared with the case where the response time run-over rate was the “run-over region” or “normal region” in the previous observation.

When a certain virtual server whose response time run-over rate was the “run over region” in the previous observation has a response time run-over rate which becomes the “excess region” in the current observation, this indicates that accesses from users rapidly decreased from the previous observation.

The resource allocation control unit 150 recovers hardware resources by a threshold value of the recovery count threshold value corrected by “−2” and thereby recovers hardware resources faster from virtual servers with response time run-over rates changing from the “run-over region” to the “excess region” compared with the case where the response time run-over rate was the “normal region” or “excess region” in the previous observation.

When a certain virtual server whose response time run-over rate was the “normal region” or “excess region” in the previous observation has a response time run-over rate which becomes the “excess region” in the current observation, the resource allocation control unit 150 corrects the recovery count threshold value by “−1”.

A certain virtual server whose response time run-over rate becomes the “excess region” due to the reduction of the recovery count threshold value has hardware resources recovered from it faster than the case of no correction.

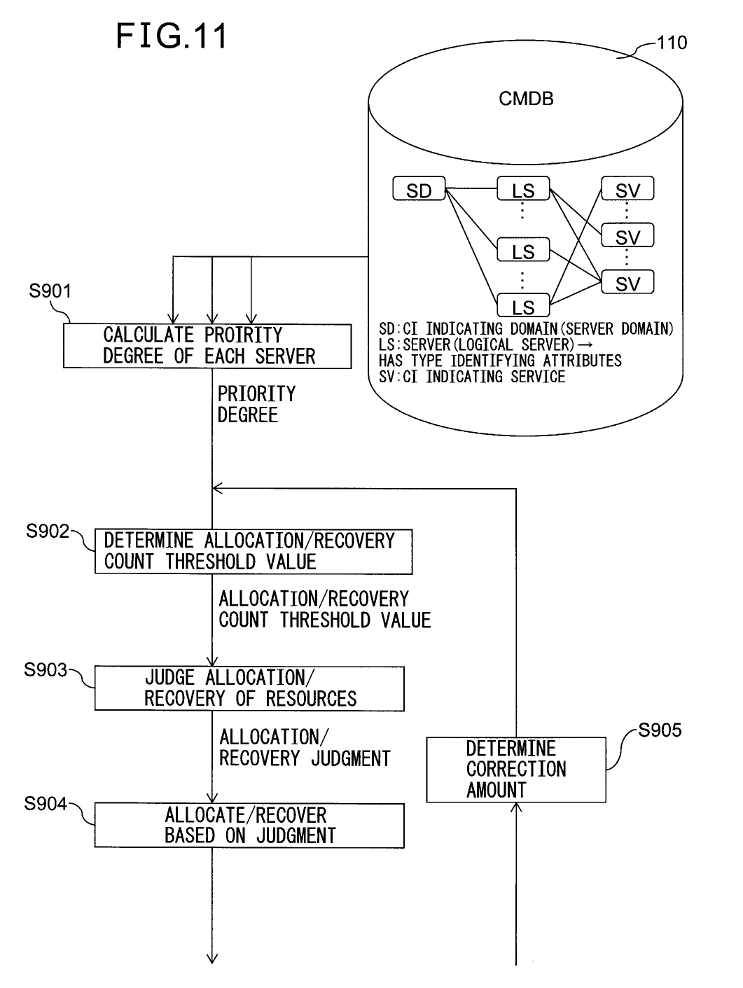

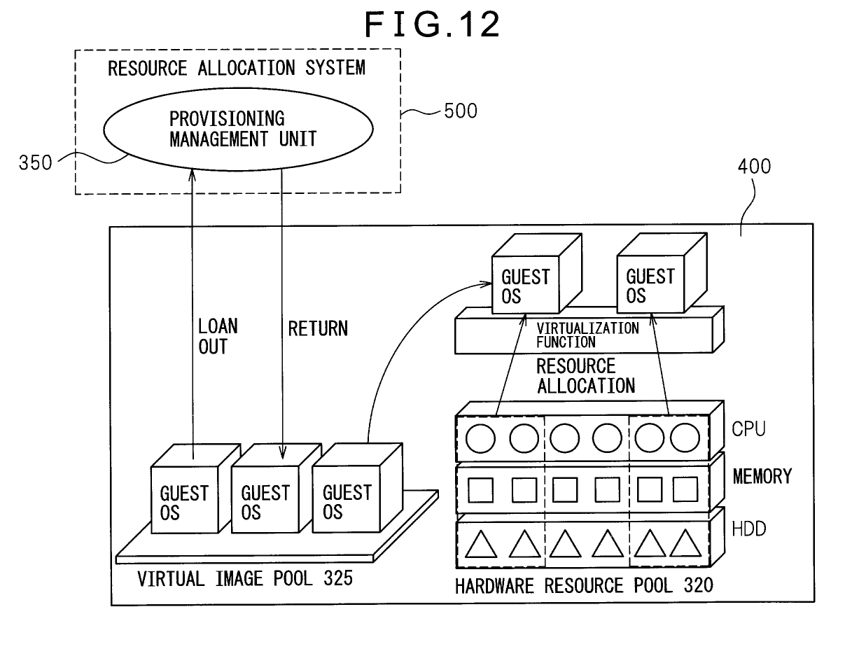

FIG. 11 is a view for explaining an outline of the processing which the priority degree calculation unit and resource allocation control unit perform. FIG. 11 will be used to explain the routine from the calculation of the priority degree to the allocation or recovery of hardware resources.

The priority degree calculation unit 140 uses the information in the CMDB 110 to calculate the priority degree of each virtual server (S901). The resource allocation control unit 150 refers to the resource allocation control information 120 and determines the allocation or recovery count threshold value (S902). At that step, the resource allocation control unit 150 may also use a corrected allocation or recovery count threshold value.

The resource allocation control unit 150 refers to the request response time information 130 to calculate the response time run-over rate and judges what extent of time the period when the response time run-over rate is the allocation threshold value or more or the period when it is the recovery threshold value or less so as to thereby judge the allocation or recovery of hardware resources (S903).

The resource allocation control unit 150 requests allocation or recovery of hardware resources to or from the programming management unit 350 based on the judgment (S904). Further, the resource allocation control unit 150 determines a correction amount of the allocation or recovery count from the response time run-over rate (S905).

### [5] Programming Management Unit and Physical Server

FIG. 12 is a view which illustrates an example of the relationship between the programming management unit and guest OS's. The programming management unit 350 manages the hardware resources, which are comprised of at least one physical server 400, as a hardware resource pool 320.

The hardware resource pool 320 virtualizes the hardware resources and forms a virtual image pool 325 of the prepared plurality of virtual servers. The physical server 400 in the data center is managed as the virtual image pool 325 of the plurality of virtual servers by virtualization technology.

When the number of users increases etc. and thereby the functions or capacities from the virtual servers increase, the allocation of hardware resources to the guest OS's is dynamically increased from the hardware resource pool 320 accordingly whereby the hardware resources in the data center are effectively utilized.

The programming management unit 350, for example, is included in the hardware resource allocation system (resource control system 500) and allocates hardware resources to the virtual servers in accordance with hardware resource allocation or recovery requests.

Note that, the programming management unit 350 controls the input and output by virtual servers to the hardware sources and changes the allocation of hardware resources to the virtual servers by the physical server 400 running the virtualization software.

For example, new allocation of hardware resources to the virtual servers includes an increase in the allocation of the CPU usage rate to a certain virtual server or an increase in the capacity of the physical memory which is allocated to a virtual server.

Further, recovery of hardware resources from the virtual servers includes a reduction in the allocation of the CPU usage rate to a certain virtual server or a reduction in the capacity of the physical memory which is allocated to a virtual server. Note that, the programming management unit 350 may also be provided as a separate physical server from the resource control system 500.

### [6] Resource Control Processing

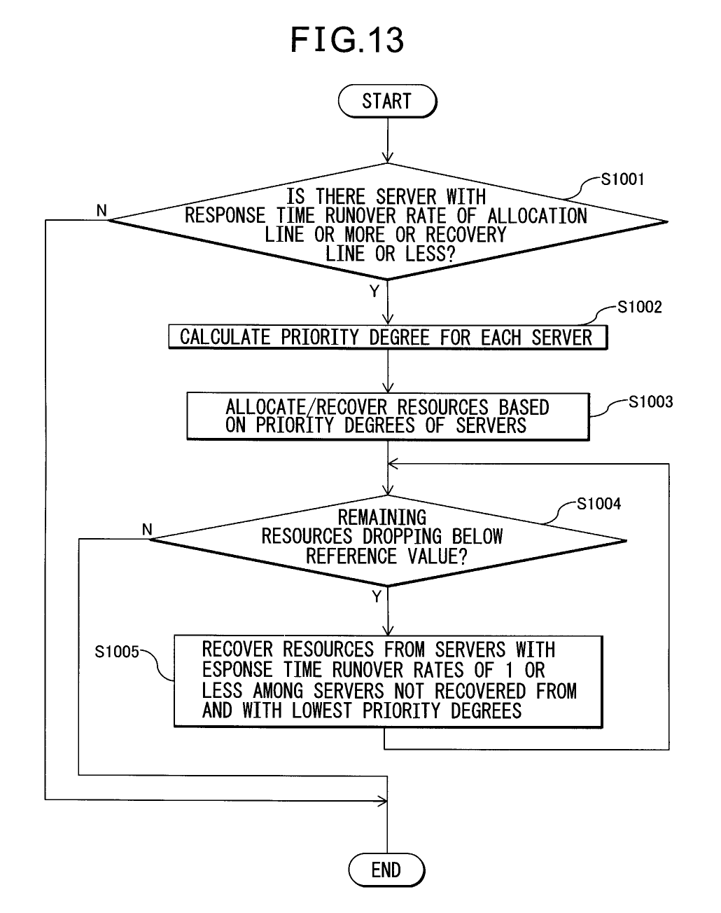

FIG. 13 is a flowchart which illustrates an overall outline of the processing by the resource control system. First, the resource allocation control unit 150 judges if there is a virtual server where the response time run-over rate is the allocation threshold value or more or recovery threshold value or less (S1001).

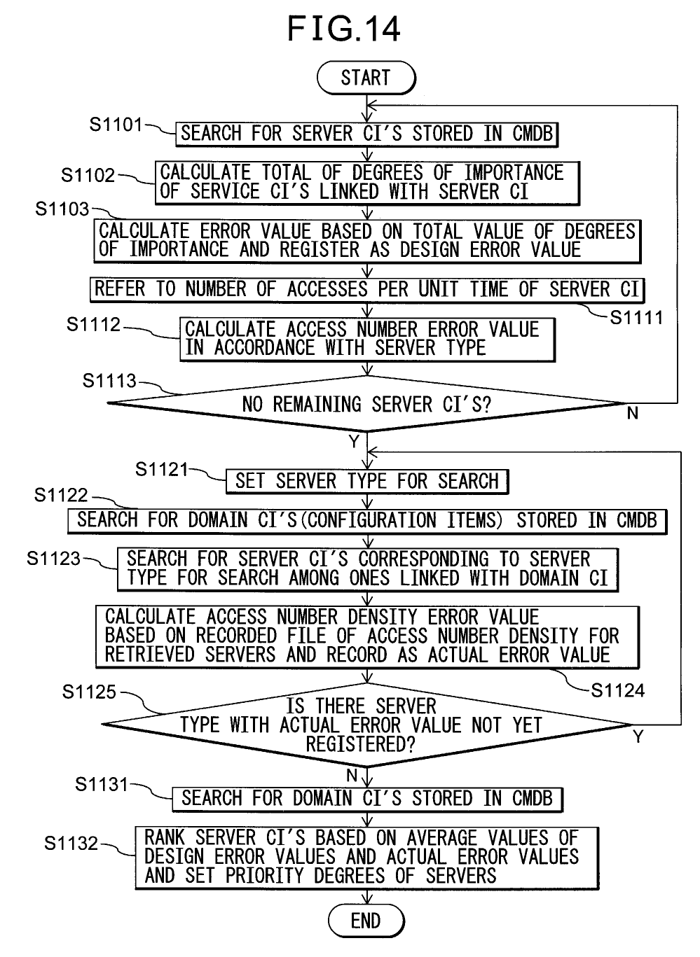

If there is a virtual server where the response time run-over rate is the allocation threshold value or more or recovery threshold value or less (S1001, Y), the priority degree calculation unit 140 calculates the priority degree for each virtual server (S1002). Note that, details of the processing for calculation of the priority degree will be explained later using FIG. 14. Next, the resource allocation control unit 150 allocates or recovers resources based on the priority degrees of the virtual servers (S1003).

The resource allocation control unit 150 judges if unallocated resources which are not yet allocated in the hardware resource pool 320 have dropped below a reference value (S1004). If the unallocated resources drop below the reference value (S1004, Y), the resource allocation control unit 150 recovers resources from virtual servers with a response time run-over rate of 1 or less among the virtual servers not yet recovered from and with the lowest priority degrees (S1005), then ends the processing. Further, if the unallocated resources has not dropped below the reference value (S1004, N), the resource allocation control unit 150 ends the processing.

FIG. 14 is a view illustrating an example of the flow of calculation of the priority degrees. The priority degree calculation unit 140 uses the configuration information in the CMDB 110 to calculate the priority degrees of the virtual servers. The specific processing steps are as follows:

First, by executing the later explained S1101 to S1103, the design error value is calculated. The priority degree calculation unit 140 searches for the server CI's which are stored in the CMDB 110 (S1101). The priority degree calculation unit 140 calculates the total of the degrees of importance of the service CI's linked with the server CI's by the configuration information 850 in the CMDB 110 (S1102). The priority degree calculation unit 140 calculates the error value based on the total value of the degrees of importance and stores this as the design error value in the storage unit 520 (S1103).

Next, by executing the later explained S1111 to S1113, the actual error value is calculated. The priority degree calculation unit 140 refers to the number of accesses per unit time of the server CI's in the configuration information 850 in the CMDB 110 (S1111). The priority degree calculation unit 140 uses the configuration information which is stored in the CMDB 110 to classify the virtual servers by type, then calculates the error value in the number of accesses per unit time (S1112). The priority degree calculation unit 140 may find the error value for each server type to thereby cancel out bias in the number of accesses due to the differences in server types.

When the calculation has not finished for all of the virtual servers (S1113, N), the system returns again to S1101 and repeats the calculation of the error value. When the calculation has been finished for all of the virtual servers (S1113, Y), the priority degree calculation unit 140 sets the server type being searched for (S1121) and searches for the domain CI's which are stored in the CMDB 110 (S1122).

The priority degree calculation unit 140 searches for the server CI's linked with the domain CI's for information corresponding to the server type being searched for (S1123). The priority degree calculation unit 140 calculates the access number density error for a retrieved virtual server based on the recorded file of the access number density and registers this as the actual error value (S1124). The priority degree calculation unit 140 judges if there is a server type with an actual error value not yet registered inside the CMDB 110 (S1125).

If there is a server type with an actual error value not yet registered (S1125, Y), the priority degree calculation unit 140 returns to S1121 and again registers the actual error value. If there is no server type with an actual error value not yet registered (S1125, N), the priority degree calculation unit 140 searches for the domain CI's which are stored in the CMDB 110 (S1131). Further, the priority degree calculation unit 140 ranks the server CI's based on the average values of the design error values and actual error values and sets the priority degrees of the servers (S1132), then ends the processing.

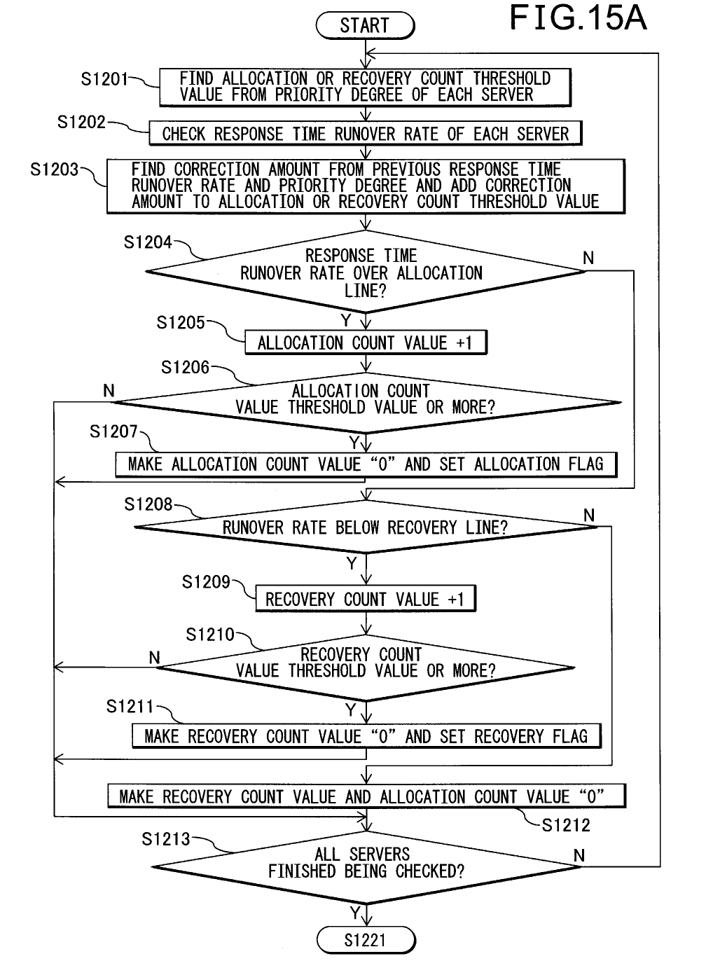

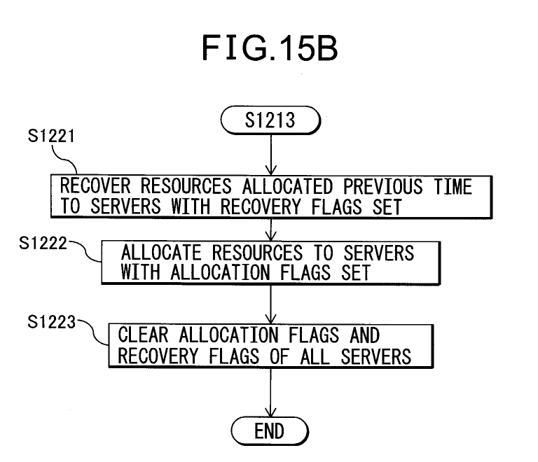

FIG. 15A and FIG. 15B are flowcharts which illustrate one example of control processing of the resource allocation amount. The resource allocation control unit refers to the data in the request response time information and resource allocation control information and determines the timing and amount of resource allocation or recovery. The specific processing steps are as follows:

First, the resource allocation control unit 150 finds the allocation or recovery count threshold value from the priority degrees of the virtual servers in the configuration information (S1201). The resource allocation control unit 150 checks the response time run-over rates of the virtual servers (S1202). The resource allocation control unit 150 finds correction amounts from the previous response time run-over rate and priority degree and adds correction amounts to the allocation or recovery count threshold value (S1203). The resource allocation control unit 150 judges if a response time run-over rate is the allocation threshold value or more (S1204).

If a response time run-over rate is the allocation threshold value or more (S1204, Y), the resource allocation control unit 150 adds “1” to the allocation count value (S1205). The resource allocation control unit 150 judges if the allocation count value is the threshold value or more (S1206).

If the allocation count value is the threshold value or more (S1206, Y), the resource allocation control unit 150 makes the allocation count value “0” to set the allocation flag (S1207) and executes the processing which is illustrated at step S1213.

If the response time run-over rate is not the allocation threshold value or more (S1204, N), the resource allocation control unit 150 judges if the response time run-over rate is the recovery threshold value or less (S1208). If the response time run-over rate is the recovery threshold value or less (S1208, Y), the resource allocation control unit 150 adds “1” to the recovery count value (S1209).

If the response time run-over rate has not fallen below the recovery threshold value (S1208, N), the resource allocation control unit 150 makes the recovery count value and allocation count value “0” (S1212) and executes the processing which is illustrated at step S1213.

Next, the resource allocation control unit 150 judges if the recovery count value is the threshold value or more (S1210). If the recovery count value is the threshold value or more (S1210, Y), the resource allocation control unit 150 makes the recovery count value “0” to set the recovery flag (S1211), then executes the processing which is illustrated at step S1213. If the recovery count value is not the threshold value or more (S1210, N), the resource allocation control unit 150 executes the processing which is illustrated at step S1213.

At step S1213, the resource allocation control unit 150 judges if all virtual servers have finished being checked. When all virtual servers have not finished being checked (S1213, N), the processing which is illustrated at S1201 is executed. When all virtual servers have finished being checked (S1213, Y), the resource allocation control unit 150 recovers the resources which were allocated the previous time from the virtual servers at which the recovery flags have been set (S1221) and allocates resources to the virtual servers at which allocation flags have been set (S1222).

Note that, the processings of S1221 and S1222 include the resource allocation control unit 150 requesting that the programming management unit 350 allocate or recover resources and of the programming management unit 350 allocating or recovering hardware resources to or from virtual servers. The resource allocation control unit 150 clears the allocation flags and recovery flags of all virtual servers (S1223) and ends the resource allocation or recovery processing flow.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A resource control system comprising:
a control unit configured to control to make hardware resources which are allocated to a virtual server increase if an extent of deterioration of response characteristics to requests for processing to the virtual server becomes greater than a certain first extent, and configured to control to change the certain first extent to a smaller second extent of deterioration in accordance with an increase in frequency of access to the virtual server.

2. The resource control system as claimed in claim 1, wherein
the control unit controls to make hardware resources which are allocated to the virtual server decrease if an extent of deterioration of response characteristics to requests for processing to the virtual server becomes smaller than an extent of deterioration smaller than the certain first extent and constituting a certain third extent; and
the control unit controls to change the certain third extent to a fourth extent of deterioration larger than the certain third extent in accordance with an increase in frequency of access to the virtual server.

3. The resource control system as claimed in claim 1, wherein
the control unit makes the hardware resources which are allocated to the virtual server increase in a shorter time when an extent of deterioration of response characteristics to requests for processing to the virtual server becomes larger than the second extent compared with when it becomes larger than the certain first extent.

4. The resource control system as claimed in claim 2, wherein
the control unit makes the hardware resources which are allocated to the virtual server decrease in a longer time when an extent of deterioration of response characteristics to requests for processing to the virtual server becomes smaller than the fourth extent compared with when it becomes smaller than the certain third extent.

5. The resource control system as claimed in claim 1, wherein the resource control system further comprises:
a storage unit configured to store priority degrees which correspond to changes of frequency of access to the virtual server.

6. The resource control system as claimed in claim 5, wherein
the priority degrees are set for a plurality of virtual servers, and
the control unit controls the plurality of virtual servers in accordance with the priority degrees of the virtual servers.

7. A resource control method comprising:
controlling to make hardware resources which are allocated to a virtual server increase if an extent of deterioration of response characteristics to requests for processing to the virtual server becomes greater than a certain first extent; and
controlling to change the certain first extent to a smaller second extent of deterioration in accordance with an increase in frequency of access to the virtual server.

8. The resource control method as claimed in claim 7, wherein the resource control method further comprises:
controlling to make hardware resources which are allocated to the virtual server decrease if an extent of deterioration of response characteristics to requests for processing to the virtual server becomes smaller than an extent of deterioration smaller than the certain first extent and constituting a certain third extent; and
controlling to change the certain third extent to a fourth extent of deterioration larger than the certain third extent in accordance with an increase in frequency of access to the virtual server.

9. A computer-readable, non-transitory medium storing a resource control program for controlling an amount of allocation of hardware resources to a virtual server, wherein the resource control program causes a computer to execute:
controlling to make hardware resources which are allocated to a virtual server increase if an extent of deterioration of response characteristics to requests for processing to the virtual server becomes greater than a certain first extent; and
controlling to change the certain first extent to a smaller second extent of deterioration in accordance with an increase in frequency of access to the virtual server.

10. The computer-readable, non-transitory medium storing the resource control program as claimed in claim 9, wherein the resource control program further causes the computer to execute:
controlling to make hardware resources which are allocated to the virtual server decrease if an extent of deterioration of response characteristics to requests for processing to the virtual server becomes smaller than an extent of deterioration smaller than the certain first extent and constituting a certain third extent; and
controlling to change the certain third extent to a fourth extent of deterioration larger than the certain third extent in accordance with an increase in frequency of access to the virtual server.
